(19) United States
(12) Patent Application Publication
(10) Pub. No.: US 2025/0216199 A1
(43) Pub. Date: Jul. 3, 2025

(54) GYRO SENSOR

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Shota HARADA, Nisshin-shi (JP); Keitaro ITO, Nisshin-shi (JP)

(21) Appl. No.: 18/913,219

(22) Filed: Oct. 11, 2024

(30) Foreign Application Priority Data
Dec. 27, 2023 (JP) 2023-221263

(51) Int. Cl. G01C 19/5776; G01C 25/00

(52) U.S. Cl. CPC G01C 19/5776; G01C 25/00

(57) ABSTRACT

A gyro sensor includes: a first PLL circuit; a second PLL circuit; a first demodulator that calculates a first demodulation output based on a first detection signal in the first oscillation mode and a first drive signal, and a second demodulation output based on a second detection signal in the second oscillation mode and a second drive signal; and a second demodulator that calculates a third demodulation output based on the first detection signal and the second drive signal, and a fourth demodulation output based on the second detection signal and the first drive signal. A control circuit outputs a control signal that causes an oscillation axis and an electrode axis to coincide with each other based on an input signal regarding an amplitude and a phase from a demodulation output calculator.

### CROSS REFERENCE TO RELATED APPLICATION

This application is based on Japanese Patent Application No. 2023-221263 filed on Dec. 27, 2023, the disclosure of which is incorporated herein by reference.

### TECHNICAL FIELD

The present disclosure relates to a gyro sensor.

### BACKGROUND

In a vibratory gyro sensor, an accuracy of a sensor can be improved by matching resonance frequencies of two oscillation modes excited by an oscillator which is a sensor element, that is, by mode matching.

A gyro sensor for constantly maintaining the mode match includes a first PLL circuit that performs frequency control of a drive signal for oscillating the oscillator in the first oscillation mode, and a second PLL circuit that performs frequency control of a drive signal for oscillating the oscillator in the second oscillation mode.

### SUMMARY

According to an aspect of the present disclosure, a gyro sensor includes: an oscillator having a first oscillation mode and a second oscillation mode having different resonance frequencies; a mounting substrate having electrodes facing the oscillator; a first PLL circuit that controls a frequency of a drive signal for oscillating the oscillator in the first oscillation mode; and a second PLL circuit that controls a frequency of a drive signal for oscillating the oscillator in the second oscillation mode. A radial direction is defined relative to an axis which is a virtual straight line that passes through a center of a region surrounded by the electrodes, along a thickness direction of the mounting substrate. An electrode axis is defined by the radial direction being two directions along a drive electrode used for driving the first oscillation mode and the second oscillation mode among the electrodes. Two directions along the radial direction and along a oscillation direction of the first oscillation mode and the second oscillation mode are defined as an oscillation axis. A first demodulator calculates a first demodulation output on a basis of a first detection signal from the electrode that detects oscillation in the first oscillation mode among the electrodes and a first drive signal having a frequency for resonantly driving the first oscillation mode and output from the first PLL circuit, and a second demodulation output on a basis of a second detection signal from the electrode that detects oscillation in the second oscillation mode among the electrodes and a second drive signal having a frequency for resonantly driving the second oscillation mode and output from the second PLL circuit. A second demodulator calculates a third demodulation output on a basis of the first detection signal and the second drive signal, and a fourth demodulation output on a basis of the second detection signal and the first drive signal. A first demodulation output calculator calculates an amplitude and a phase of the first oscillation mode on a basis of the first demodulation output and the third demodulation output. A second demodulation output calculator calculates an amplitude and a phase of the second oscillation mode on a basis of the second demodulation output and the fourth demodulation output. A control circuit outputs a control signal that causes the oscillation axis and the electrode axis to coincide with each other on a basis of an input signal regarding the amplitude and the phase from the first demodulation output calculator or the second demodulation output calculator.

### BRIEF DESCRIPTION OF DRAWINGS

FIG. 1 is a perspective view illustrating an exemplary structure of a sensor element.

FIG. 2 is a cross-sectional view taken along line II-II in FIG. 1.

FIG. 3 is a diagram corresponding to FIG. 2, and is a sectional view illustrating another exemplary structure.

FIG. 4 is an explanatory diagram of an oscillation axis and an electrode axis of the sensor element.

FIG. 5 is a diagram illustrating a two-dimensional oscillation model of an oscillator of the gyro sensor.

FIG. 6 is an explanatory diagram of types of voltages applied to constituent electrodes of a gyro sensor.

FIG. 7 is a block diagram illustrating a configuration of a gyro sensor according to a first embodiment.

FIG. 8 is an explanatory diagram of a demodulator and a demodulation output calculator in the gyro sensor according to the first embodiment.

FIG. 9 is an explanatory diagram of a first oscillation mode and a second oscillation mode in the oscillator oscillating in a wineglass mode.

FIG. 10 is an explanatory diagram of demodulation output.

FIG. 11 is a diagram illustrating a relationship between a demodulation output, an output waveform, and Ow polarity.

FIG. 12 is a block diagram illustrating a modification of the gyro sensor according to the first embodiment.

FIG. 13 is a block diagram illustrating a configuration of a gyro sensor according to a second embodiment.

FIG. 14 is an explanatory diagram of a demodulator and a demodulation output calculator in the gyro sensor according to the second embodiment.

FIG. 15 is a perspective view illustrating another exemplary structure of the sensor element.

### DESCRIPTION OF EMBODIMENTS

Conventionally, in a vibratory gyro sensor, it is known that accuracy of a sensor can be improved by matching resonance frequencies of two oscillation modes excited by an oscillator which is a sensor element, that is, by mode matching. In the oscillator, normally, an oscillation axis and an electrode axis are different or two resonance frequencies ω₁ and ω₂ are different unless special processing for adjusting an oscillation mode is performed. Hereinafter, for convenience of description, the resonance frequency of a first oscillation mode of the oscillator is simply referred to as a “resonance frequency ω₁”, and the resonance frequency of a second oscillation mode of the oscillator is simply referred to as a “resonance frequency ω₂”. In the present specification, the two resonance frequencies ω₁ and ω₂ of the oscillator may be collectively referred to as “mode frequencies ω₁ and ω₂”.

Therefore, in the mode match, in order to improve the accuracy of the sensor, in a case of an electrostatic drive type, the mode frequencies ω₁ and ω₂ (ω₂>ω₁) are coincided with each other by adjusting a state of the oscillation mode by an electrostatic force due to a voltage application by using an electric spring effect. Hereinafter, for convenience of description, an angle formed by the oscillation axis and the electrode axis of the oscillator is referred to as θ_{ωα}, a frequency difference of the mode frequency is referred to as Δ_{ωα}, and the angle formed by the oscillation axis and the electrode axis and the difference of the mode frequency at a time of voltage application when the oscillator is driven are referred to as θ_{ωβ} and Δ_{ωα}, respectively.

The gyro sensor for constantly maintaining the mode match includes a first PLL circuit that performs frequency control of a drive signal for oscillating the oscillator in the first oscillation mode, and a second PLL circuit that performs frequency control of a drive signal for oscillating the oscillator in the second oscillation mode. The gyro sensor performs control such that two resonance frequencies ω₁ and ω₂ of the oscillator become reference frequencies ω_{ref} in the mode match. PLL is an abbreviation for phase locked loop.

The gyro sensor includes two PLL circuits and constantly maintains a mode match. However, in order to satisfy two conditions of ω₂−ω₁=Δ_{ωα}=0 and θ_{ωα}=0, special processing for adjusting the oscillation mode or precise voltage application is required in advance. However, in a case where there is no special processing or the like and the sensor element is a sensor element in which Δ_{ωα}≠0 and θ_{ωα}≠0 in an initial state, it is necessary to control θ_{ωβ} independently of Δ_{ωβ} in order to always maintain the mode match.

The present disclosure provides a gyro sensor capable of feedback control of θ_{ωβ} at a time of voltage application in an oscillation mode independently of control of Δ_{ωβ} even when Δ_{ωα}≠0 and θ_{ωα}≠0 in an initial state.

According to an aspect of the present disclosure, a gyro sensor includes: an oscillator having a first oscillation mode and a second oscillation mode having different resonance frequencies; a mounting substrate having electrodes facing the oscillator; a first PLL circuit that controls a frequency of a drive signal for oscillating the oscillator in the first oscillation mode; and a second PLL circuit that controls a frequency of a drive signal for oscillating the oscillator in the second oscillation mode. When a radial direction that passes through a center of a region surrounded by the electrodes and has, as an axis, a virtual straight line along a thickness direction of the mounting substrate are defined as an electrode axis, the radial direction being two directions along a drive electrode used for driving the first oscillation mode and the second oscillation mode among the electrodes. Two directions along the radial direction and along an oscillation direction of the first oscillation mode and the second oscillation mode are defined as an oscillation axis. A first demodulator calculates a first demodulation output on a basis of a first detection signal from the electrode that detects oscillation in the first oscillation mode among the electrodes and a first drive signal having a frequency for resonantly driving the first oscillation mode and output from the first PLL circuit, and a second demodulation output on a basis of a second detection signal from the electrode that detects oscillation in the second oscillation mode among the electrodes and a second drive signal having a frequency for resonantly driving the second oscillation mode and output from the second PLL circuit. A second demodulator calculates a third demodulation output on a basis of the first detection signal and the second drive signal, and a fourth demodulation output on a basis of the second detection signal and the first drive signal. A first demodulation output calculator calculates an amplitude and a phase of the first oscillation mode on a basis of the first demodulation output and the third demodulation output. A second demodulation output calculator calculates an amplitude and a phase of the second oscillation mode on a basis of the second demodulation output and the fourth demodulation output. A control circuit outputs a control signal that causes the oscillation axis and the electrode axis to coincide with each other on a basis of an input signal regarding the amplitude and the phase from the first demodulation output calculator or the second demodulation output calculator.

As a result, the gyro sensor includes two independent PLL circuits and the first demodulator that performs demodulation based on the first detection signal and the first drive signal of the first oscillation mode of the oscillator and demodulation based on the second detection signal and the second drive signal of the second oscillation mode of the oscillator. In addition, the gyro sensor includes the second demodulator that performs demodulation based on the first detection signal and the second drive signal and demodulation based on the second detection signal and the first drive signal. Furthermore, the gyro sensor includes the demodulation output calculator that calculates the amplitude and the phase of the two oscillation modes on the basis of the demodulation outputs of the first and second demodulators, and the control circuit that outputs the control signal that causes the oscillation axis of the oscillator to coincide with the electrode axis on the basis of the input signal from the demodulation output calculator. As a result, in the initial state, even when the two resonance frequency differences Δ_{ωα}≠0 of the oscillator and θ_{ωα}≠0 in which the oscillation axis and the electrode axis are deviated from each other, the gyro sensor can perform feedback control of θ_{ωβ}=0 on the basis of the two types of demodulators and the demodulation output of the demodulators.

Hereinafter, embodiments of the present disclosure will be described with reference to the drawings. In the following embodiments, the same or equivalent portions are denoted by the same reference signs, and the description thereof will be made.

### First Embodiment

A gyro sensor 1 according to a first embodiment will be described with reference to the drawings.

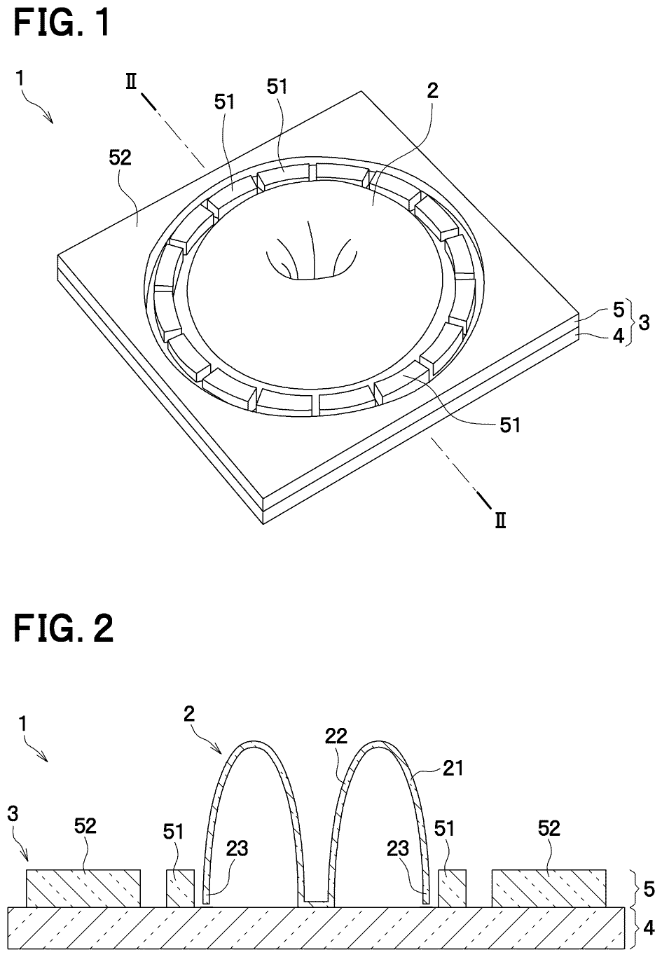

As illustrated in FIG. 1, for example, the gyro sensor 1 according to the present embodiment includes an oscillator 2 and a mounting substrate 3, and includes a sensor element in which the oscillator 2 is mounted on the mounting substrate 3. The gyro sensor 1 can detect an angular velocity and a rotation angle applied to the gyro sensor 1 on the basis of a change in electrostatic capacitance between a part of the thin oscillator 2 capable of oscillating in a first oscillation mode and a second oscillation mode and plural first electrode portions 51 of the mounting substrate 3. The gyro sensor 1 can control a constant mode match by a control unit 10 to be described later.

For example, as illustrated in FIG. 2, the oscillator 2 is a minute oscillating body having a three-dimensional substantially symmetrical structure including a curved surface 21 including an outer shape of a substantially hemispherical three-dimensional curved surface, and a mounting portion 22 extending from a vertex side of a virtual hemisphere formed by the curved surface 21 toward a center of the hemisphere. In the oscillator 2, for example, conductive films (not illustrated) are formed on both a front surface and a back surface, and a voltage can be applied from the mounting substrate 3. In the oscillator 2, for example, a rim 23 which is an end of the curved surface 21 on a side opposite to the mounting portion 22 faces the first electrode portions 51, and the rim 23 vibrates in a resonance mode due to an electrostatic force generated between the first electrode portion 51 and the rim 23.

Note that the oscillator 2 can be manufactured, for example, by preparing a plate material including any reflow material such as quartz and a mold having a bowl-shaped recess and a support column located at a center of the recess, setting the plate material in the mold, and heating and softening the recess while decompressing the recess.

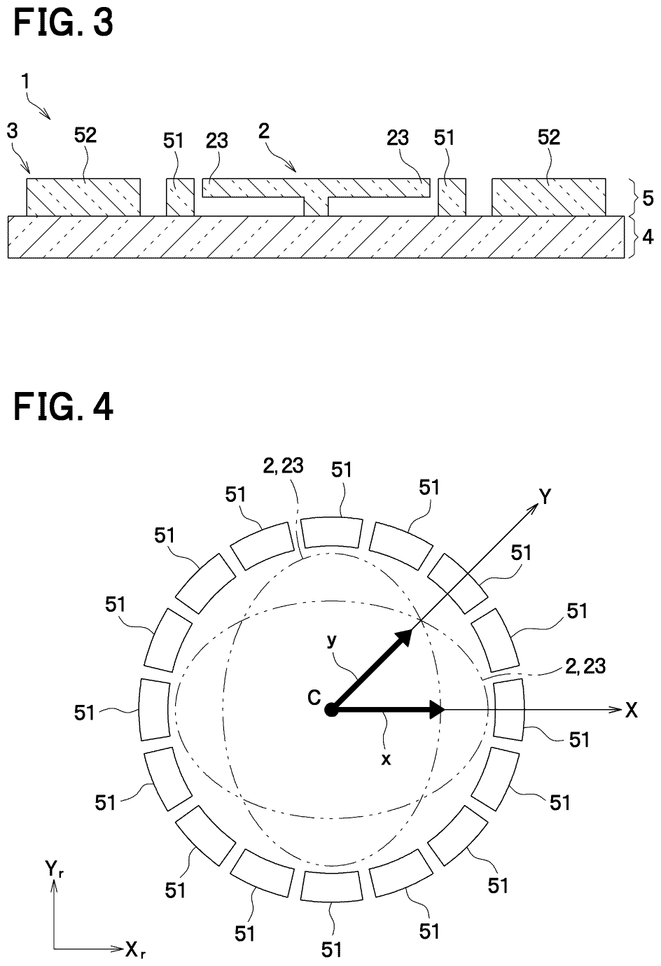

Alternatively, for example, as illustrated in FIG. 3, the oscillator 2 may have a substantially disk shape having a disk-shaped portion and a columnar connection portion bonded to the mounting substrate 3 at a center of the disk-shaped portion. In this case, in the oscillator 2, an end of a hollow disk-shaped portion is the rim 23, and the portion is surrounded by the first electrode portions 51. As described above, the oscillator 2 only needs to have a structure capable of oscillating in the first oscillation mode and the second oscillation mode by a drive electrode among the first electrode portions 51, and may have another known structure other than the above structure.

For example, as illustrated in FIGS. 1 and 2, the mounting substrate 3 includes a lower substrate 4 and an upper substrate 5, and these substrates are bonded to each other. For example, the mounting substrate 3 is obtained by performing wiring film formation or the like on the lower substrate 4 including borosilicate glass as an insulating material, then anodically bonding the upper substrate 5 including silicon as a semiconductor material to the lower substrate 4, and performing patterning. In the mounting substrate 3, for example, dry etching such as DRIE is performed on the upper substrate 5 after anodic bonding to form the first electrode portions 51 and second electrode portions 52. The DRIE is an abbreviation of deep reactive ion etching. In the mounting substrate 3, for example, in a case where the oscillator 2 has a bird bus shape illustrated in FIG. 2, an annular groove (not illustrated) along the rim 23 may be formed in the lower substrate 4 as necessary so as not to come into contact with the rim 23.

The plurality of first electrode portions 51 faces the rim 23 of the oscillator 2, for example, and is arranged apart from each other at equal intervals so as to form one ring on a plane of the mounting substrate, and an electrode film (not illustrated) is formed on each top surface. The potential of the plurality of first electrode portions 51 can be controlled by, for example, connecting a wire (not illustrated) to the electrode film (not illustrated) and electrically connecting the electrode film to an external circuit board or the like. All of the plurality of first electrode portions 51 are separated from the rim 23 of the oscillator 2 by a predetermined distance, each of the first electrode portions forms the oscillator 2 and a capacitor, and electrostatic capacitance between the first electrode portions and the oscillator 2 can be detected. Some of the plurality of first electrode portions 51 are detection electrodes that detect electrostatic capacitance, and the others are drive electrodes that apply electrostatic force to the rim 23 of the oscillator 2.

For example, as illustrated in FIG. 1, the second electrode portion 52 has a single frame shape surrounding the plurality of first electrode portions 51, an electrode film (not illustrated) is formed on the top surface, and a wire (not illustrated) is connected to the electrode film (not illustrated). The second electrode portion 52 is connected to a conductive film (not illustrated) of the oscillator 2 by wiring (not illustrated) or the like, and is configured to be capable of voltage application.

The above is a basic configuration of a sensor portion of the gyro sensor 1 according to the present embodiment. The control unit 10 that executes drive control of the gyro sensor 1 will be described later.

FIG. 1 illustrates, as a representative example, a case where the mounting substrate 3 has 16 first electrode portions 51 and one frame-shaped second electrode portion 52, but the present disclosure is not limited to this example. In the mounting substrate 3, for example, the number, arrangement, shape, and the like of the first electrode portion 51 and the second electrode portion 52 may be appropriately changed.

Next, an oscillation model of the oscillator 2 and various voltages in the plurality of first electrode portions 51 will be described with reference to FIGS. 4 to 6. FIG. 6 illustrates the plurality of first electrode portions 51 in a state where the mounting substrate 3 is viewed from above, and the outline of the rim 23 of the oscillator 2 is indicated by a two-dot chain line.

When viewed from a normal direction with respect to a planar direction formed by the mounting substrate 3 (hereinafter referred to as “top view”), the oscillator 2 is brought into a resonance state in which the number of antinodes and nodes in an oscillation amplitude of the outline of the rim 23 is 2n as illustrated in FIG. 4, for example, by voltage application to some of the first electrode portions 51. The reference sign “n” is an integer of two or more, and such a resonance state of the oscillator 2 is referred to as a “wineglass mode”. FIG. 4 illustrates, as a representative example, a state in which oscillation axes x and y to be described later coincide with electrode axes X and Y in the resonance mode of n=2 in the wineglass mode, but the oscillator 2 can be oscillated even in a high-order wineglass mode of n=3 or more.

Hereinafter, for convenience of description, as illustrated in FIG. 4, with a center position of the rim 23 in top view as a center C, a radial direction around a virtual straight line passing through the center C along a thickness direction of the mounting substrate 3 is referred to as a “substrate radial direction”, and a circumferential direction around the virtual straight line is referred to as a “substrate circumferential direction”. Of the directions along the substrate radial direction, a direction passing through the position of an antinode of oscillation in the rim 23 of the oscillator 2 in the first oscillation mode (resonance frequency ω₁) is referred to as an “oscillation axis x”, and a direction passing through the position of a node is referred to as an “oscillation axis y”. In the wineglass mode with n=k (k: an integer of two or more), an angle between the oscillation axis x and the oscillation axis y is (360/4k) °. For example, in the wineglass mode with n=2, the angle between the oscillation axis x and the oscillation axis y is 45°.

For example, the plurality of first electrode portions 51 are arranged apart from each other along the substrate circumferential direction, and are arranged such that distances from the rim 23 in a non-oscillating state are substantially the same. For convenience of description, for example, as illustrated in FIG. 4, one direction on an actual plane on which the plurality of first electrode portions 51 is arranged is referred to as an “Xᵣ direction”, a direction orthogonal to the Xᵣ direction on the plane is referred to as a “Yᵣ direction”, and the plane is referred to as an “XᵣYᵣ plane”. One direction in the XᵣYᵣ plane is defined as an “electrode axis X”, and a direction oriented when the electrode axis X is rotated counterclockwise (360/4k)° along the substrate circumferential direction on the XᵣYᵣ plane is defined as an “electrode axis Y”.

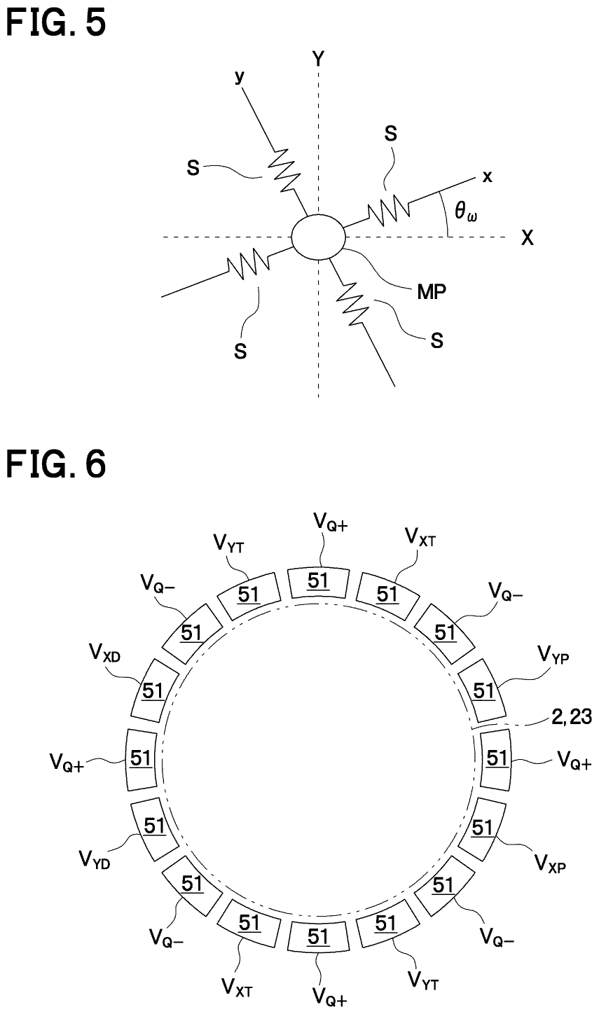

For example, as illustrated in FIG. 5, the oscillator 2 has a mass point MP and a spring S installed in the directions of the oscillation axes x and y, and can be regarded as an oscillating body of a two-degree-of-freedom system that oscillates on a two-dimensional plane. FIG. 5 illustrates that the oscillation axes x and y and the electrode axes X and Y on the XᵣYᵣ plane are converted into an orthogonal coordinate system, and the origin of the oscillation axes x and y and the origin of the electrode axes X and Y coincide with each other. Normally, in the sensor element in which the oscillator 2 is mounted on the mounting substrate 3, the electrode axes X and Y and the oscillation axes x and y are different from each other, that is, the oscillation axes and the electrode axes do not overlap each other unless special processing or the like is performed. That is, assuming that the angle between the electrode axes X and Y and the oscillation axes x and y in the orthogonal coordinate system illustrated in FIG. 5 is θ_{ω}, the sensor element normally satisfies θ_{ω}≠0.

The oscillation axes x and y of the oscillator 2 respectively correspond to oscillation directions of the first oscillation mode and the second oscillation mode having different mode frequencies ω₁ and ω₂. That is, in the sensor element, unless special processing or the like is performed, normally, Δ_{ω} which is a difference between the mode frequencies ω₁ and ω₂ (>ω₁) does not become zero, and Δ_{ω}≠0. In the gyro sensor 1, mode match control is executed by the control unit 10 to be described later in order to improve sensor accuracy.

In the case of the wineglass mode of n=2, an equation of motion of the oscillation model of the two-degree-of-freedom system illustrated in FIG. 5 is expressed by the following equation (1).

$$[ \begin{matrix}\ddot{X} \\ \ddot{Y}\end{matrix} ] + [ \begin{matrix}\frac{2}{τ} + Δ ( \frac{1}{τ} ) cos 2 {θ}_{τ} & Δ ( \frac{1}{τ} ) sin 2 {θ}_{τ} - 2 k Ω \\ Δ ( \frac{1}{τ} ) sin 2 {θ}_{τ} + 2 k Ω & \frac{2}{τ} - Δ ( \frac{1}{τ} ) cos 2 {θ}_{τ}\end{matrix} ] [ \begin{matrix}\dot{X} \\ \dot{Y}\end{matrix} ] + [ \begin{matrix}{ω}^{2} - ωΔω cos 2 {θ}_{ω} - λ ( 2 {V}_{XT}^{2} + {V}_{Q +}^{2} + {V}_{Q -}^{2} ) & - ωΔω sin 2 {θ}_{ω} - \frac{λ}{2} ( {V}_{Q +}^{2} - {V}_{Q -}^{2} ) \\ - ωΔω sin 2 {θ}_{ω} - \frac{λ}{2} ( {V}_{Q +}^{2} - {V}_{Q -}^{2} ) & {ω}^{2} + ωΔω cos 2 {θ}_{ω} - λ ( 2 {V}_{XT}^{2} + {V}_{Q +}^{2} + {V}_{Q -}^{2} )\end{matrix} ] [ \begin{matrix}X \\ Y\end{matrix} ] = [ \begin{matrix}{F}_{X} \\ {F}_{Y}\end{matrix} ] \qquad ( 1 )$$

V_{XT}, V_{YT}, V_{Q+}, and V_{Q-} in the equation (1) are various voltages applied to the first electrode portions 51, respectively. V_{XT}, V_{YT}, V_{Q+}, V_{Q-}, and various voltages applied to the other first electrode portions 51 will be described later.

In the equation (1), T is a time constant, θ_{τ} is an angle formed by a damper axis and the electrode axis, Ω is an angular velocity input to the sensor element, ω is a resonance angle frequency of the oscillator 2, and Fₓ and F_{y} are forces acting on the oscillator from the directions of the electrode axes X and Y. Specifically, ω₁ and ω₂ in the equation (1) are resonance frequencies in the directions of the oscillation axes x and y before voltage application, respectively, and ω=(ω₁²+ω₂²)/2 and ωΔω=(ω₁²−ω₂²/2. For the time constant τ, the following equations hold: 1/τ={(1/τ₁)+(1/τ₂)}/2 and Δ(1/τ)=(1/τ₁)−(1/τ₂). τ₁ and τ₂ are attenuation time constants in the directions of the oscillation axes x and y before voltage application. In addition, λ in the equation (1) is a conversion coefficient depending on the oscillator 2 and an electrode shape for converting an applied voltage into an effect of an electric spring.

The mode frequencies ω₁ and ω₂ of the oscillator 2 are expressed by the following equation (2), in which ω_{1,2}² is a resonance frequency in the directions of the oscillation axes x and y when a voltage is applied.

$${ω}_{1 , 2}^{2} = {ω}^{2} - λ ( {V}_{XT}^{2} + {V}_{YT}^{2} + {V}_{Q +}^{2} + {V}_{Q -}^{2} ) \pm \sqrt{{( ωΔω cos 2 {θ}_{ω} - λ ( {V}_{XT}^{2} - {V}_{YT}^{2} ) )}^{2} + {( ωΔω sin 2 {θ}_{ω} + \frac{λ}{2} ( {V}_{Q +}^{2} - {V}_{Q -}^{2} ) )}^{2}} \qquad ( 2 )$$

For example, according to Yi. Zhou, IEEE SENSORS JOURNAL, Vol. 21, No. 24, and Dec. 15, 2021, the mode match corresponds to control in which the first term and the second term of the square root of the equation (2) are 0 at the mode frequency. Assuming that Ow is an angle formed by the electrode axes X and Y of the oscillator 2 and the oscillation axes x and y when a voltage is applied to the plurality of first electrode portions 51, and that Δ_{ωβ} is a mode frequency difference, the mode match corresponds to control in which θ_{ωβ}=0 and Δ_{ωα}=0.

In order to perform control to obtain θ_{ωβ}=0 and Δ_{ωα}=0, the control unit 10 applies and detects various voltages to the plurality of first electrode portions 51, for example, as illustrated in FIG. 6. The applied voltages and detection voltages of the plurality of first electrode portions 51 are, for example, V_{XD}, V_{XT}, V_{XP}, V_{YD}, V_{YT}, V_{YP}, V_{Q+}, and V_{Q-}. The detection voltage may be referred to a detection signal or detection voltage signal. The detection signal is not limited to the voltage and may be a current. In other words, the detection signal is voltage/current signal, more specifically, a digital signal obtained by converting the voltage/current.

V_{XD} is based on signals output from a PLL circuit 120 and an AGC circuit 121 described later, and is a drive voltage for resonantly driving the oscillator 2 in the first oscillation mode of the resonance frequency ω₁. V_{XT} is output from a PI circuit 122 to be described later, and is an applied voltage for controlling the resonance frequency ω₁ of the first oscillation mode and setting Δ_{ωβ}=0 by loosening the spring S of the oscillator 2 in the direction of the electrode axis X by an electric spring effect. V_{XP} is a first detection voltage of oscillation on the electrode axis X of the oscillator 2. V_{XD}, V_{XT}, and V_{XP} correspond to, for example, the first electrode portions 51 located on the electrode axis X among the plurality of first electrode portions 51.

V_{YD} is based on signals output from a PLL circuit 110 and an AGC circuit 111 described later, and is a drive voltage for resonantly driving the oscillator 2 in the second oscillation mode of the resonance frequency ω₂. V_{YT} is output from a PI circuit 112 to be described later, and is an applied voltage for controlling the resonance frequency ω₂ of the second oscillation mode and setting Δ_{ωβ}=0 by loosening the spring S of the oscillator 2 in the direction of the electrode axis Y by an electric spring effect. V_{YP} is a second detection voltage of oscillation on the electrode axis Y of the oscillator 2, and is output from the first electrode portion 51 disposed on the oscillation axis x. V_{YD}, V_{YT}, and V_{YP} correspond to, for example, the first electrode portions 51 located on the electrode axis Y among the plurality of first electrode portions 51.

Note that V_{XT} and V_{YT} are applied to some of the plurality of first electrode portions 51 for a mode match that bring the difference between the two mode frequencies of the oscillator 2 to 0, but at least one of V_{XT} or V_{YT} is controlled by the control unit 10. Specifically, in the mode match, the control unit 10 controls one of V_{XT} or V_{YT} to be applied in a case where a higher frequency (for example, ω₂) of the two mode frequencies ω₁ or ω₂ of the oscillator 2 is adjusted to a lower frequency (for example, ω₁). On the other hand, in a case of a mode match in which the two mode frequencies ω₁ and ω₂ of the oscillator 2 are adjusted to a predetermined reference frequency ω_{ref}, the control unit 10 controls both V_{XT} or V_{YT} to be applied. Whether to control one of V_{XT} or V_{YT} to be applied or both of V_{XT} and V_{YT} to be applied can be appropriately designed, and either control may be used.

V_{Q+} and V_{Q-} are control voltages for causing the oscillation axes x and y to coincide with the electrode axes X and Y and setting θ_{ωβ}=0, and are applied to, for example, the first electrode portion 51 that is not on the electrode axes X and Y. For example, as illustrated in FIG. 5, V_{Q+} is a control voltage in a case where the oscillation axes x and y in top view are rotated clockwise. V_{Q+} is a control voltage in a case where the oscillation axes x and y in top view are rotated counterclockwise. Both V_{Q+} and V_{Q-} are applied to any one of the first electrode portions 51, but one of V_{Q+} or V_{Q-} is controlled to rotate the oscillation axes x and y in a direction opposite to the direction of deviation in accordance with the direction of deviation between the oscillation axes x and y and the electrode axes X and Y.

Next, the control unit 10 of the gyro sensor 1 will be described.

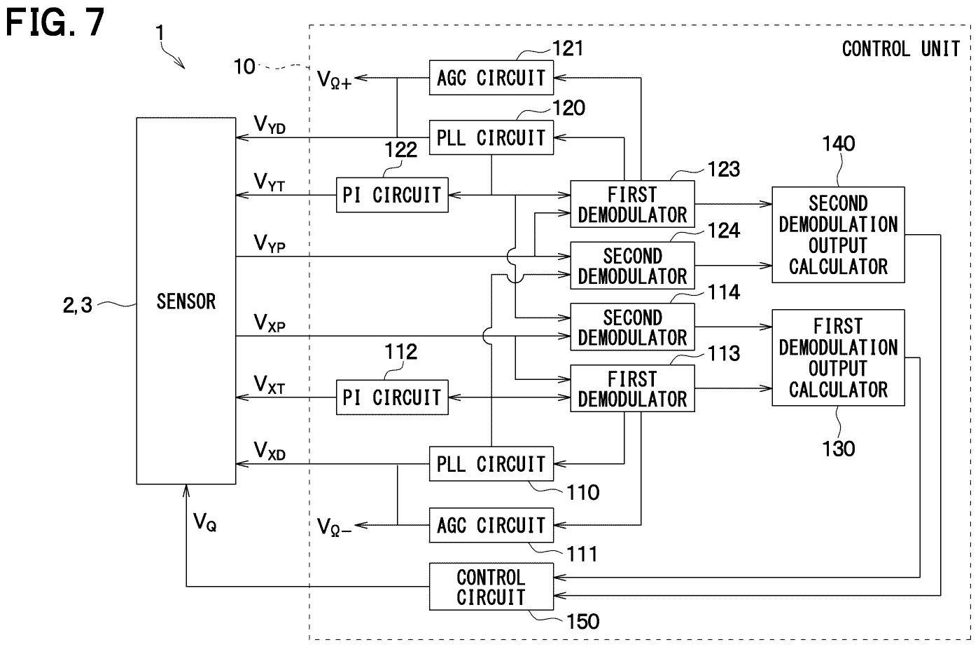

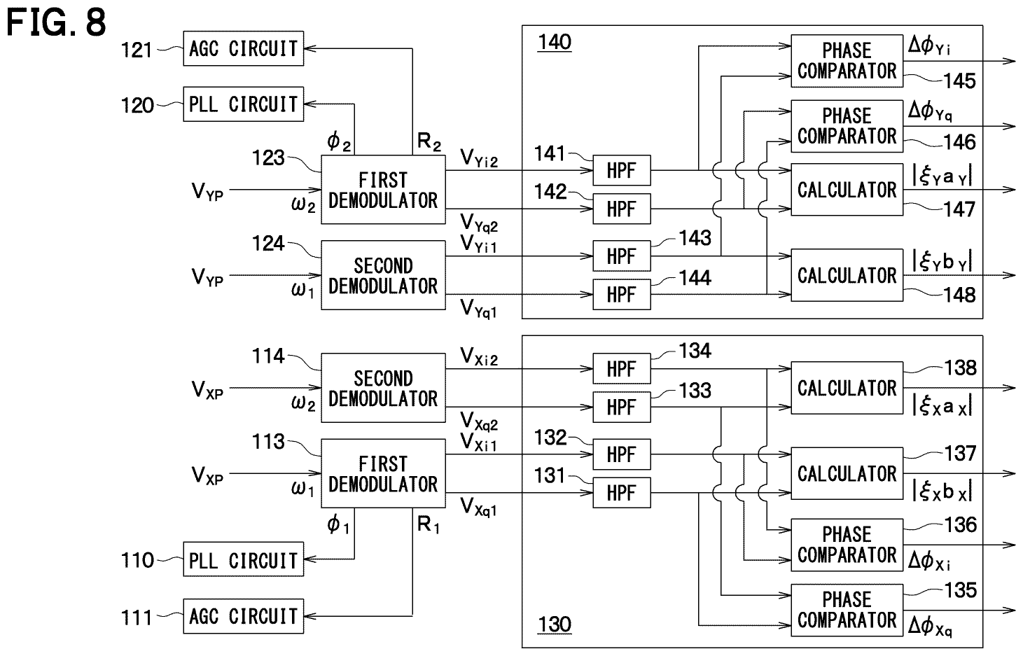

Hereinafter, for convenience of description, as illustrated in FIG. 7, a sensor element including the oscillator 2 and the mounting substrate 3 illustrated in FIG. 1 and a circuit (not illustrated) used for applying a voltage to the plurality of first electrode portions 51 are collectively referred to as a “sensor unit”. Examples of the circuit not illustrated here include a current-voltage conversion circuit, a DAC, an ADC, and the like. In FIG. 6, V_{Q+} and V_{Q-} are collectively referred to as “V_{Q}” for ease of viewing. The voltages V_{XD}, V_{XT}, V_{YD}, V_{YT}, and V_{Q} applied to the sensor unit in FIG. 7 and the detection voltages V_{XP} and V_{YP} from the sensor unit correspond to the various voltages of the first electrode portion 51 described above.

The control unit 10 is, for example, an electronic control unit in which various electronic components such as a CPU, a ROM, and a RAM are mounted on a circuit board (not illustrated) and which executes drive control of the gyro sensor 1. CPU is an abbreviation for a central processing unit, ROM is an abbreviation for a read only memory, and RAM is an abbreviation for a random access memory. For example, as illustrated in FIG. 7, the control unit 10 includes two PLL circuits 110 and 120, two AGC circuits 111 and 121, two PI circuits 112 and 122, and two first demodulators 113 and 123. AGC is an abbreviation of automatic gain control, and is also referred to as control for automatic gain. PI is an abbreviation of proportional integral.

The PLL circuit 110, the AGC circuit 111, the PI circuit 112, and the first demodulator 113 execute, for example, control of the resonance frequency ω₁ and the amplitude of one of the two oscillation modes of the oscillator 2. The PLL circuit 120, the AGC circuit 121, the PI circuit 122, and the first demodulator 123 execute control of the resonance frequency ω₂ and the amplitude in the other oscillation mode of the oscillator 2.

The PLL circuit 110 includes, for example, an oscillation circuit (not illustrated) that generates a drive signal having a predetermined frequency, and executes frequency control of the drive signal so as to drive the oscillator 2 resonantly at the resonance frequency ω₁. The PLL circuit 110 performs the above frequency control on the basis of an input signal regarding phase information of the first oscillation mode obtained by demodulating the detection voltage V_{XP} by the first demodulator 113. The AGC circuit 111 controls the amplitude of the first oscillation mode of the oscillator 2 on the basis of, for example, an input signal from the first demodulator 113. The PI circuit 112 adjusts the resonance frequency ω₁ of the first oscillation mode of the oscillator 2 on the basis of an output signal of the PLL circuit 110, for example, and performs control to obtain Δ_{ωβ}=0. For example, the detection voltage V_{XP} and an output signal from the PLL circuit 110 are input to the first demodulator 113, and the first demodulator performs demodulation corresponding to the resonance frequency ω₁. The first demodulator 113 acquires, for example, information of a phase φ₁ and an amplitude R₁ of a detection signal corresponding to the first oscillation mode by demodulation, and feeds back the information of the phase φ₁ to the PLL circuit 110 and information of the amplitude R₁ to the AGC circuit 111. The first demodulator 113 outputs, for example, a demodulation output corresponding to the resonance frequency ω₁ to a first demodulation output calculator 130 to be described later.

Note that the PLL circuit 120, the AGC circuit 121, the PI circuit 122, and the first demodulator 123 correspond to the second oscillation mode and the resonance frequency ω₂ of the oscillator 2, and execute processing similar to the processing of the PLL circuit 110, the AGC circuit 111, the PI circuit 112, and the first demodulator 113, respectively. The PLL circuit 120 includes, for example, an oscillation circuit (not illustrated), and executes frequency control of the drive signal in order to drive the oscillator 2 in the second oscillation mode of the resonance frequency ω₂ on the basis of the input signal from the first demodulator 123. The first demodulator 123 acquires information of a phase φ₂ and an amplitude R₂ of a detection signal corresponding to the second oscillation mode by demodulation, and feeds back the information of the phase φ₂ to the PLL circuit 120 and information of the amplitude R₂ to the AGC circuit 121. Then, the first demodulator 123 outputs, for example, a demodulation output corresponding to the resonance frequency ω₂ to a second demodulation output calculator 140 to be described later. The control unit 10 outputs, for example, signals V_{Q+} and V_{Q-} according to the angular velocity input from the AGC circuit 111 or the AGC circuit 121 to the sensor unit.

The control unit 10 further includes, for example, two second demodulators 114 and 124, a first demodulation output calculator 130, a second demodulation output calculator 140, and a control circuit 150.

The second demodulator 114 acquires information of the resonance frequency ω₂ in the second oscillation mode on the basis of the drive signal output from the second PLL circuit 120, and performs demodulation corresponding to the resonance frequency ω₂ on the basis of the detection voltage V_{XP} in the first oscillation mode. In the system in which the resonant drive of the mode frequencies ω₁ and ω₂ of the oscillator 2 is maintained by the two independent PLL circuits 110 and 120, this demodulation is possible because the detection voltage V_{XP} includes information regarding an oscillation amplitude in the direction of the oscillation axis y of the second oscillation mode. The second demodulator 114 inputs the demodulation output to the first demodulation output calculator 130.

The second demodulator 124 acquires information of the resonance frequency ω₁ in the first oscillation mode on the basis of the drive signal output from the first PLL circuit 110, and performs demodulation corresponding to the resonance frequency ω₁ on the basis of the detection voltage V_{YP} in the second oscillation mode. This demodulation is possible because the detection voltage V_{YP} includes information regarding an oscillation amplitude in the direction of the oscillation axis x of the first oscillation mode, as described above. The second demodulator 124 inputs the demodulation output to the second demodulation output calculator 140.

The first demodulation output calculator 130 executes calculation for performing control to obtain ω_{ωβ}=0 on the basis of demodulation outputs V_{Xi1}, V_{Xq1}, V_{Xi2}, and V_{Xq2} obtained by demodulating the detection voltage V_{XP} by the first demodulator 113 and the second demodulator 114. For example, as illustrated in FIG. 8, the first demodulation output calculator 130 includes a plurality of HPFs 131 to 134, phase comparison units 135 and 136, and calculators 137 and 138, and acquires information of calculation and phase difference necessary for performing control to obtain θ_{ωβ}=0. The HPF is an abbreviation of a high pass filter, and for example, an arbitrary high-pass filter such as a DC cut filter is used. For example, a phase comparator is used as each of the phase comparison units 135 and 136, and outputs a signal corresponding to a phase difference between two input signals. Results of various calculations by the first demodulation output calculator 130 are output to, for example, the control circuit 150.

The second demodulation output calculator 140 executes calculation for performing control to obtain θ_{ωβ}=0 on the basis of demodulation outputs V_{Yi1}, V_{Yq1}, V_{Yi2}, and V_{Yq2} obtained by demodulating the detection voltage V_{YP} by the first demodulator 123 and the second demodulator 124. For example, the second demodulation output calculator 140 includes a plurality of HPFs 141 to 144, phase comparison units 145 and 146, and calculators 147 and 148, and acquires information of calculation and phase difference necessary for performing control to obtain ω_{ωβ}=0. Results of various calculations by the second demodulation output calculator 140 are output to, for example, the control circuit 150. The HPFs 141 to 144, the phase comparison units 145 and 146, and the calculators 147 and 148 have configurations similar to the configurations of the HPFs 131 to 134, the phase comparison units 135 and 136, and the calculators 137 and 138, respectively.

Note that the demodulation outputs V_{Xi1}, V_{Xq1}, V_{Xi2}, V_{Xq2}, V_{Yi1}, V_{Yq1}, V_{Yi2}, and V_{Yq2}, and calculations and the like in the demodulation output calculators 130 and 140 will be described later.

The control circuit 150 calculates the voltage V_{Q} as a control signal for setting θ_{ωβ}=0 on the basis of the calculation results in the demodulation output calculators 130 and 140, outputs V_{Q+} and V_{Q-} to the sensor unit, and controls one of V_{Q+} or V_{Q-}. The control circuit 150 is, for example, a PI circuit.

The basic configuration of the control unit 10 has been described above. The control unit 10 controls Δ_{ωα}=0 by the PLL circuits 110 and 120, the AGC circuits 111 and 121, and the PI circuits 112 and 122, and performs control of θ_{ωβ}=0 by the second demodulators 114 and 124, the demodulation output calculators 130 and 140, and the control circuit 150. That is, in the control unit 10, a control loop of Δ_{ωβ}=0 and a control loop of θ_{ωβ}=0 are configured independently, and in the mode match, the control of θ_{ωβ}=0 can be executed independently of the control of Δ_{ωβ}=0 in parallel with the control of Δ_{ωα}=0. As a result, even when θ_{ω}≠0 and Δ_{ω}≠0 in an initial state, the gyro sensor 1 is configured such that two independent controls of the control of θ_{ωβ}=0 and the control of Δ_{ωα}=0 work appropriately, and the mode match control of Δ_{ωα}=0 can be performed.

Note that, in the control unit 10, for example, a circuit that outputs various voltages V_{XT}, V_{XD}, V_{YT}, V_{YD}, V_{Q+}, or V_{Q-} to the sensor unit may include a DAC (not illustrated) as necessary. The DAC is an abbreviation of a digital to analog converter. In the control unit 10, for example, a circuit that detects the detection voltages V_{XP} and V_{YP} may include an ADC (not illustrated) as necessary. The ADC is an abbreviation for an analog to digital converter.

Next, calculation processing in the demodulators 114 and 124 and the demodulation output calculators 130 and 140 will be described. Here, a case of n=2 in the wineglass mode will be described as a representative example, and a case of n=3 or higher is basically the same, and thus will not be described.

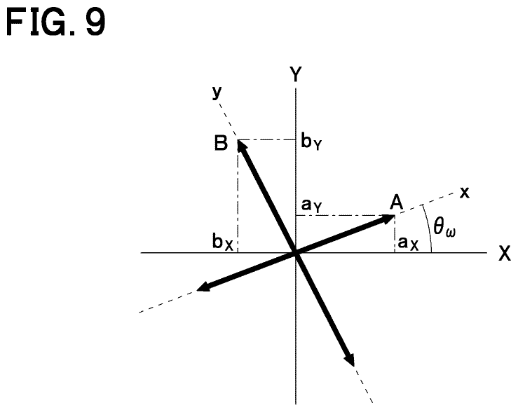

In a case where the first and second oscillation modes of the resonance mode of n=2 are both driven to resonate, the oscillator 2 oscillates along two orthogonal oscillation axes x and y, for example, as illustrated in FIG. 9. The oscillation amplitude and the mode frequency on the oscillation axis x are A and ω₁, respectively, the oscillation amplitude and the mode frequency on the oscillation axis y are B and ω₂, respectively, and the angle between the oscillation axis x and the electrode axis X is θ_{ω}. At this time, the oscillation amplitudes of the oscillation axes x and y at a time t are expressed by the following equations (3) and (4).

$$x = A sin ( {w}_{1} t + {φ}_{1} ) \qquad ( 3 )$$

$$y = B sin ( {w}_{2} t + {φ}_{2} ) \qquad ( 4 )$$

1 in the equation (3) and φ₂ in the equation (4) are phases for an external force applied from each direction. Assuming that the respective components of the oscillation of the amplitude A on the electrode axes X and Y are a_{X} and a_{Y}, and the respective components of the oscillation of the amplitude B on the electrode axes X and Y are b_{X} and b_{Y}, θ_{ω}, which is the deviation angle between the oscillation axis x and the electrode axis X, is expressed by the following equation (5) from the orthogonality of the oscillation axes x and y.

$$\vert \frac{{a}_{X}}{{a}_{Y}} \vert = \vert \frac{{b}_{X}}{{b}_{Y}} \vert = tan ( \vert {θ}_{ω} \vert ) \qquad ( 5 )$$

The conversion between the electrode axes X and Y and the oscillation axes x and y is expressed by the following equation (6).

$$( \begin{matrix}X \\ Y\end{matrix} ) = ( \begin{matrix}cos {θ}_{ω} & sin {θ}_{ω} \\ - sin {θ}_{ω} & cos {θ}_{ω}\end{matrix} ) ( \begin{matrix}x \\ y\end{matrix} ) \qquad ( 6 )$$

Since the electrode axis X is the sum of X components of the two oscillation modes and the electrode axis Y is the sum of Y components of the two oscillation modes, the oscillation amplitudes of the electrode axes X and Y at the time t are expressed by the following equations (7) and (8).

$$X = {a}_{X} sin ( {ω}_{1} t + {φ}_{1} ) + {b}_{X} sin ( {ω}_{2} t + {φ}_{2} ) \qquad ( 7 )$$

$$Y = {a}_{Y} sin ( {ω}_{1} t + {φ}_{1} ) + {b}_{Y} sin ( {ω}_{2} t + {φ}_{2} ) \qquad ( 8 )$$

Note that the components a_{X}, b_{X}, a_{Y}, and b_{Y} in the equations (7) and (8) are a_{X}=Acosθ_{ω}, b_{X}=−B sinθ_{ω}, a_{Y}=A sinθ_{ω}, and b_{Y}=Bcosθ_{ω}, respectively, in the example illustrated in FIG. 9. In addition, assuming that conversion coefficients from the amplitude to the voltage according to a detection method are ξ_{X} and ξ_{Y}, the voltages V_{XP} and V_{YP} at the detection electrodes of the electrode axes X and Y are expressed by the following equations (9) and (10).

$${V}_{XP} = {ξ}_{X} \{ {a}_{X} sin ( {ω}_{1} t + {φ}_{1} ) + {b}_{X} sin ( {ω}_{2} t + {φ}_{2} ) \} \qquad ( 9 )$$

$${V}_{YP} = {ξ}_{Y} \{ {a}_{Y} sin ( {ω}_{1} t + {φ}_{1} ) + {b}_{Y} sin ( {ω}_{2} t + {φ}_{2} ) \} \qquad ( 10 )$$

The first demodulator 113 calculates the demodulation outputs V_{Xi1} and V_{Xq1} for the external force on the oscillation axes x and y on the basis of the voltage V_{XP} of the equation (9). The demodulation outputs V_{Xi1} and V_{Xq1} are calculated on the basis of the detection voltage V_{XP}, and are a demodulation output in phase with the drive signal having the resonance frequency ω₁ and a demodulation output in quadrature with the drive signal. The demodulation output V_{Xi1} is calculated by performing processing of multiplying the voltage V_{XP} by sinω₁t as expressed by the following equation (11) and passing through a low-pass filter as expressed by the equation (12) to eliminate the term of a second harmonic and a frequency sum.

$$\begin{matrix}{V}_{XP} sin {ω}_{1} t = {ξ}_{X} \{ {a}_{X} sin ( {ω}_{1} t + {ϕ}_{1} ) + {b}_{X} sin ( {ω}_{2} t + {ϕ}_{2} ) \} sin {ω}_{1} t \\ \begin{matrix}= \frac{{ξ}_{X}}{2} \{ {a}_{X} cos ϕ ( 1 - cos 2 {ω}_{1} t ) + {a}_{X} sin {ϕ}_{1} sin 2 {ω}_{1} t \\ + {b}_{X} cos {ϕ}_{2} ( - cos ( {ω}_{1} + {ω}_{2} ) t + cos Δω t ) \\ + {b}_{X} sin {ϕ}_{2} ( sin ( {ω}_{1} + {ω}_{2} ) t - sin Δω t ) \}\end{matrix}\end{matrix} \qquad ( 11 )$$

$$\begin{matrix}{V}_{Xi 1} = {\vert 2 {V}_{XP} sin {ω}_{1} t \vert}_{LPF} \\ = {ξ}_{X} \{ {a}_{X} cos {ϕ}_{1} + {b}_{X} ( cos {ϕ}_{2} cos Δω t - sin {ϕ}_{2} sin Δω t ) \} \\ = {ξ}_{X} \{ {a}_{X} cos {ϕ}_{1} + {b}_{X} cos ( Δω t + {ϕ}_{2} ) \}\end{matrix} \qquad ( 12 )$$

|f(t)|_{LPF} in the equation (12) means a calculation for erasing a term of a second harmonic and a frequency sum passing through the low-pass filter. The same applies to the following equations (14), (16), and (18).

The demodulation output V_{Xq1} is calculated by performing processing of multiplying the voltage V_{XP} by cos ω₁t as expressed by the following equation (13) and performing calculation of erasing unnecessary terms through the low-pass filter as expressed by the equation (14).

$$\begin{matrix}{V}_{XP} cos {ω}_{1} t = {ξ}_{X} \{ {a}_{X} sin ( {ω}_{1} t + {ϕ}_{1} ) + {b}_{X} sin ( {ω}_{2} t + {ϕ}_{2} ) \} cos {ω}_{1} t \\ \begin{matrix}= \frac{{ξ}_{X}}{2} \{ {a}_{X} cos {ϕ}_{1} sin 2 {ω}_{1} t + {a}_{X} sin {ϕ}_{1} ( 1 + cos 2 {ω}_{1} t ) \\ + {b}_{X} cos {ϕ}_{2} ( sin ( {ω}_{1} + {ω}_{2} ) t + sin Δω t ) \\ + {b}_{X} sin {ϕ}_{2} ( cos ( {ω}_{1} + {ω}_{2} ) t + cos Δω t ) \}\end{matrix}\end{matrix} \qquad ( 13 )$$

$$\begin{matrix}{V}_{Xq 1} = {\vert 2 {V}_{XP} cos {ω}_{1} t \vert}_{LPF} \\ = {ξ}_{X} \{ {a}_{X} sin {ϕ}_{1} + {b}_{X} ( cos {ϕ}_{2} sin Δω t + sin {ϕ}_{2} cos Δω t ) \} \\ = {ξ}_{X} \{ {a}_{X} sin {ϕ}_{1} + {b}_{X} sin ( Δω t + {ϕ}_{2} ) \}\end{matrix} \qquad ( 14 )$$

The second demodulator 114 calculates the demodulation outputs V_{Xi2} and V_{Xq2} for the external force on the oscillation axes x and y on the basis of the voltage V_{XP} of the equation (9). The demodulation outputs V_{Xi2} and V_{Xq2} are calculated on the basis of the detection voltage V_{XP}, and are a demodulation output in phase with the drive signal having the resonance frequency ω₂ and a demodulation output in quadrature with the drive signal. The second demodulator 114 acquires, for example, a drive signal for resonantly driving the oscillator 2 at the resonance frequency ω₂ from the second PLL circuit 120, and calculates the demodulation outputs V_{Xi2} and V_{Xq2}. The demodulation output V_{Xi2} is calculated by performing processing of multiplying the voltage V_{XP} by sin (ω₂t+Δφ) as expressed by the following equation (15) and performing calculation of erasing unnecessary terms through the low-pass filter as expressed by the equation (16). Note that Δφ is a phase of an output signal of the oscillation circuit (not illustrated) in the PLL circuit 110 when the output signal of the oscillation circuit (not illustrated) in the PLL circuit 120 is used as a reference.

$${V}_{XP} sin ( {w}_{2} t + Δφ ) = {ξ}_{X} \{ {a}_{X} sin ( {w}_{1} t + {φ}_{1} ) + {b}_{X} sin ( {w}_{2} t + {φ}_{1} ) \} sin ( {w}_{2} t + Δφ ) \qquad ( 15 )$$

$$\begin{matrix}{V}_{Xi 2} = {\vert 2 {V}_{XP} sin ( {ω}_{2} t + Δϕ ) \vert}_{LPF} \\ = {ξ}_{X} \{ {b}_{X} cos ( {ϕ}_{2} - Δϕ ) + {a}_{X} cos ( Δω t - {ϕ}_{1} + Δϕ ) \}\end{matrix} \qquad ( 16 )$$

The demodulation output V_{Xq2} is calculated by performing processing of multiplying the voltage V_{XP} by cos (ω₂t+Δφ) as expressed by the following equation (17) and performing calculation of erasing unnecessary terms through the low-pass filter as expressed by the equation (18).

$${V}_{XP} cos ( {w}_{2} t + Δφ ) = {ξ}_{X} \{ {a}_{X} sin ( {w}_{1} t + {φ}_{1} ) + {b}_{X} sin ( {w}_{2} t + {φ}_{1} ) + {b}_{x} sin ( {w}_{2} t + {φ}_{2} ) \} cos ( {w}_{2} t + Δφ ) \qquad ( 17 )$$

$$\begin{matrix}{V}_{Xq 2} = {\vert 2 {V}_{XP} cos ( {ω}_{2} t + Δϕ ) \vert}_{LPF} \\ = {ξ}_{X} \{ {b}_{X} sin ( {ϕ}_{2} - Δϕ ) + {a}_{X} sin ( {Δω}_{t} - {ϕ}_{1} + Δϕ ) \}\end{matrix} \qquad ( 18 )$$

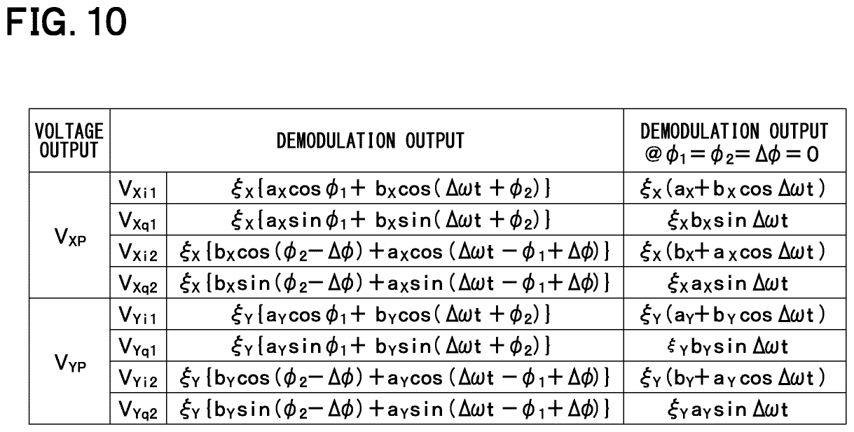

The first demodulator 123 calculates the demodulation outputs V_{Yi2} and V_{Yq2} for the external force on the oscillation axes x and y on the basis of the detection voltage V_{YP} of the equation (10). The second demodulator 124 acquires, for example, a drive signal for resonantly driving the oscillator 2 at the resonance frequency ω₁ from the first PLL circuit 110, and calculates the demodulation outputs V_{Yi1} and V_{Yq1}. The demodulation outputs V_{Yi2} and V_{Yq2} are calculated on the basis of the detection voltage V_{YP}, and are a demodulation output in phase with the drive signal having the resonance frequency ω₂ and a demodulation output in quadrature with the drive signal. The demodulation outputs V_{Yi1} and V_{Yq1} are calculated on the basis of the detection voltage V_{YP}, and are a demodulation output in phase with the drive signal having the resonance frequency ω₁ and a demodulation output in quadrature with the drive signal. As illustrated in FIG. 10, for example, the demodulation outputs V_{Yi1}, V_{Yq1}, V_{Yi2}, and V_{Yq2} based on the detection voltage V_{YP} are calculated by calculation processing similar to V_{Xi1}, V_{Xq1}, V_{Xi2}, and V_{Xq2} described above. In a case where φ₁=φ₂=Δφ=0 is satisfied, these demodulation outputs can be transformed into mathematical expressions without terms of φ₁, φ₂, and Δφ.

Note that, hereinafter, for convenience of description, the demodulation outputs V_{Xi1} and V_{Xq1} calculated by the first demodulator 113 may be referred to as “first demodulation outputs”, and the demodulation outputs V_{Yi2} and V_{Yq2} calculated by the first demodulator 123 may be referred to as “second demodulation outputs”. The demodulation outputs V_{Xi2} and V_{Xq2} calculated by the second demodulator 114 may be referred to as “third demodulation outputs”, and the demodulation outputs V_{Yi1} and V_{Yq1} calculated by the second demodulator 124 may be referred to as “fourth demodulation outputs”. In the control unit 10, the first demodulation output calculator 130 performs calculation based on the first demodulation output and the third demodulation output, and the second demodulation output calculator 140 performs calculation based on the second demodulation output and the fourth demodulation output.

Here, the angle θ_{ω} formed by the oscillation axes x and y and the electrode axes X and Y can be calculated by the following equation (19) or (20).

$$\vert {θ}_{ω} \vert = {tan}^{- 1} ( \vert \frac{{ξ}_{Y} {a}_{Y}}{{ξ}_{X} {a}_{X}} \vert \sqrt{\frac{{C}_{X}}{{C}_{Y}}} ) \qquad ( 19 )$$

$$\vert {θ}_{ω} \vert = {tan}^{- 1} ( \vert \frac{{ξ}_{X} {b}_{X}}{{ξ}_{Y} {b}_{Y}} \vert \sqrt{\frac{{C}_{Y}}{{C}_{X}}} ) \qquad ( 20 )$$

When C_{X} and C_{Y} in the equations (19) and (20) are collectively denoted by Cₖ, Cₖ is expressed by the following equation (21).

$${C}_{k} = \vert {ξ}_{k}^{2} {a}_{k} {b}_{k} \vert ( k = X , Y ) \qquad ( 21 )$$

On the basis of the demodulation output calculated by the demodulators 113, 114, 123, and 124, the control unit 10 controls one of the control voltage V_{Q+} or V_{Q-} while applying the control voltages V_{Q+} and V_{Q-} from the control circuit 150 to the sensor unit such that |θ_{ω}|=0 expressed by the equation (19) or (20). |θ_{ω}|=0 is obtained when |ξ_{Y}a_{Y}|=0 or |ξ_{X}b_{X}|=0 is satisfied from the equations (19) and (20). For example, as illustrated in FIG. 8, the first demodulation output calculator 130 calculates the value of |ξ_{X}b_{X}| by performing the calculation of a sum of squares obtained by squaring each of the demodulation outputs V_{Xi1} and V_{Xq1} in φ₁=φ₂=Δφ=0 by the calculator 137. For example, the second demodulation output calculator 140 calculates the value of |ξ_{Y}b_{Y}| by performing the calculation of a sum of squares obtained by squaring each of the demodulation outputs V_{Yi2} and V_{Yq2} in φ₁=φ₂=Δφ=0 by the calculator 147. These calculation results are output to the control circuit 150, for example, and are used for feedback control in which |ξ_{Y}a_{Y}|=0 or |ξ_{X}b_{X}|=0, that is, |θ_{ω}|=0.

In addition, in the feedback control of |θ_{ω}|=0, for example, when the oscillation axes x and y are caused to coincide with the electrode axes X and Y, both the control voltages V_{Q+} and V_{Q-} are applied, but one of the control voltage V_{Q+} or V_{Q-} is controlled in accordance with a direction in which the oscillation axes x and y are desired to be rotated. Specifically, when the oscillation axes x and y are rotated counterclockwise, the control voltage of V_{Q+} is controlled, and when the oscillation axes x and y are rotated clockwise, the control voltage of V_{Q-} is controlled. For example, as illustrated in FIG. 9, when the oscillation axes x and y are deviated counterclockwise by the angle θ_{ω} with respect to the electrode axes X and Y, the control circuit 150 controls the control voltage of V_{Q-} that rotates the oscillation axes x and y of the oscillator 2 clockwise of the applied control voltages V_{Q+} and V_{Q-}.

The demodulation output calculators 130 and 140 calculate directions in which the oscillation axes x and y are rotated in the feedback control of |θ_{ω}|=0. Specifically, the first demodulation output calculator 130 calculates Δφ_{Xq} by the phase comparison unit 135 on the basis of the demodulation output V_{Xq1} after passing through the HPF 131 and the demodulation output V_{Xq2} after passing through the HPF 133. The first demodulation output calculator 130 calculates Δφ_{Xi} by the phase comparison unit 136 on the basis of the demodulation output V_{Xi1} after passing through the HPF 132 and the demodulation output V_{Xi2} after passing through the HPF 134. Similarly, the second demodulation output calculator 140 calculates Δφ_{Yq} by the phase comparison unit 146 on the basis of the demodulation output V_{Yq1} after passing through the HPF 144 and the demodulation output V_{Yq2} after passing through the HPF 142. The second demodulation output calculator 140 calculates Δφ_{Yi} by the phase comparison unit 145 on the basis of the demodulation output V_{Yi1} after passing through the HPF 143 and the demodulation output V_{Yi2} after passing through the HPF 141.

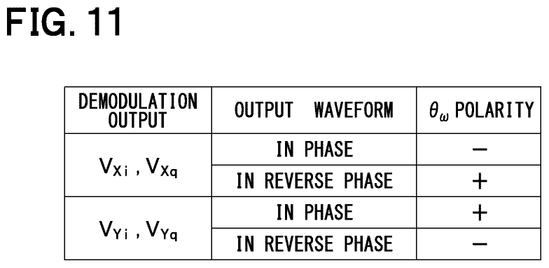

Then, for example, as illustrated in FIG. 11, the control circuit 150 determines whether the output waveforms of the demodulation outputs V_{Xi} and V_{Xq} and the output waveforms of the demodulation outputs V_{Yi} and V_{Yq} are in phase or in reverse phase on the basis of the calculated phase difference. The control circuit 150 determines whether a polarity of θ_{ω}, that is, the oscillation axes x and y are deviated clockwise or counterclockwise with respect to the electrode axes X and Y. Note that the polarity “+” of θ_{ω} in FIG. 11 means a case where the oscillation axis is deviated counterclockwise with respect to the electrode axis, and the polarity “−” of θ_{ω} means a case where the oscillation axis is deviated clockwise with respect to the electrode axis. The control circuit 150 determines one of the control voltage V_{Q+} or V_{Q-} to be output as a control target in accordance with the polarity of θ_{ω}, and controls the voltage determined as the control target while outputting V_{Q+} and V_{Q-}.

As described above, when θ_{ωα}≠0 and Δ_{ωα}≠0 in the initial state of the sensor unit, the control unit 10 is configured to be able to execute feedback control of θ_{ωβ}=0 independent of control of Δ_{ωβ}=0 at a time of voltage application on the basis of the demodulation output from the second demodulators 114 and 124.

In the present embodiment, the gyro sensor 1 includes the two independent PLL circuits 110 and 120 for maintaining the oscillator 2 in the resonance drive in the first oscillation mode and the second oscillation mode, and includes the first demodulators 113 and 123 and the second demodulators 114 and 124. The first demodulators 113 and 123 respectively calculate the demodulation outputs V_{Xi1} and V_{Xq1} based on the detection voltage in the first oscillation mode at the resonance frequency ω₁ and the first drive signal, and the demodulation outputs V_{Yi2} and V_{Xq2} based on the detection voltage in the second oscillation mode at the resonance frequency ω₂ and the second drive signal. The second demodulators 114 and 124 respectively calculate the demodulation outputs V_{Xi2} and V_{Xq2} based on the detection voltage in the first oscillation mode and the second drive signal, and the demodulation outputs V_{Yi1} and V_{Xq1} based on the detection voltage in the second oscillation mode and the first drive signal. Then, the gyro sensor 1 can calculate the control voltages V_{q+} and V_{q-} for performing control to obtain |θ_{ωβ}|=0 by the demodulation output calculators 130 and 140 on the basis of these demodulation outputs and is configured to be able to feedback to the sensor unit by the control circuit 150. Therefore, since the gyro sensor 1 includes the two PLL circuits 110 and 120, the first demodulators 113 and 123, and the second demodulators 114 and 124, can perform feedback control of |θ_{ωβ}|=0 independently of the mode match control of Δ_{ωβ}=0. Therefore, even when the sensor unit of θ_{ω}≠0 and Δω≠0 is used in the initial state, the gyro sensor 1 can perform control to always maintain the mode match without performing special processing or the like on the sensor unit.

### (Modification of First Embodiment)

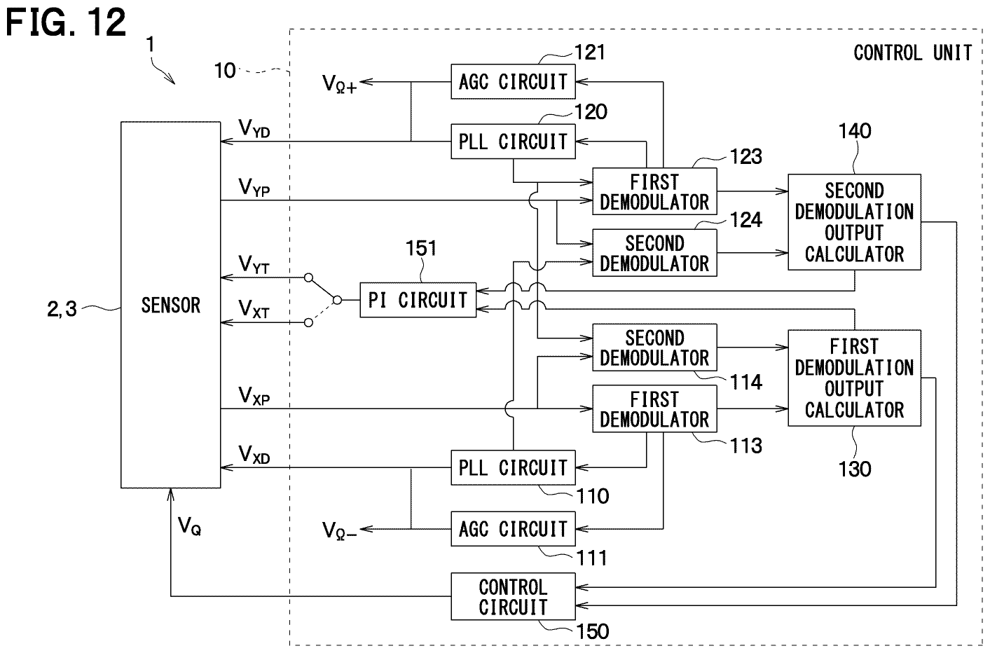

For example, as illustrated in FIG. 12, the gyro sensor 1 may have a configuration in which the control of the mode match of Δ_{ωβ}=0 is executed by the PI circuit 151 instead of the two PI circuits 112 and 122.

In this case, the control unit 10 does not include the PI circuits 112 and 122, and outputs one of the applied voltage V_{XT} or V_{YT} to the sensor unit by the PI circuit 151, for example. For example, a signal corresponding to the calculation result is input from the demodulation output calculators 130 and 140, and the PI circuit 151 outputs a voltage that changes one of the mode frequency ω₁ or ω₂ so as to obtain Δ_{ωβ}=0 on the basis of the amplitude information and the phase information obtained by the calculation. The PI circuit 151 outputs one of the voltage V_{XT} or V_{YT} to the sensor unit to so as obtain |ξ_{Y}b_{Y}|=0 or |ξ_{X}a_{X}|=0 in accordance with a magnitude relationship between the mode frequencies ω₁ and ω₂. The PI circuit 151 outputs the voltage V_{YT} so as to obtain |ξ_{Y}b_{Y}|=0 in a case where the mode frequency ω₁>ω₂, and outputs the voltage V_{XT} so as to obtain |ξ_{X}a_{X}|=0 in a case where the mode frequency ω₁<ω₂, and performs mode match control of Δ_{ωβ}=0.

In the present modification, the gyro sensor 1 can obtain a similar effect to the effect of the first embodiment.

### Second Embodiment

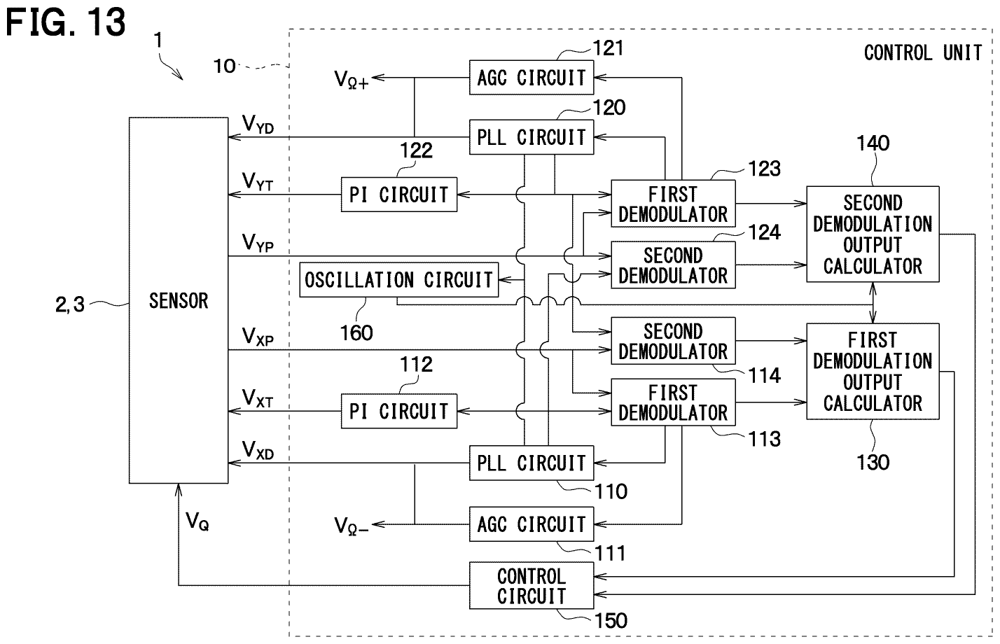

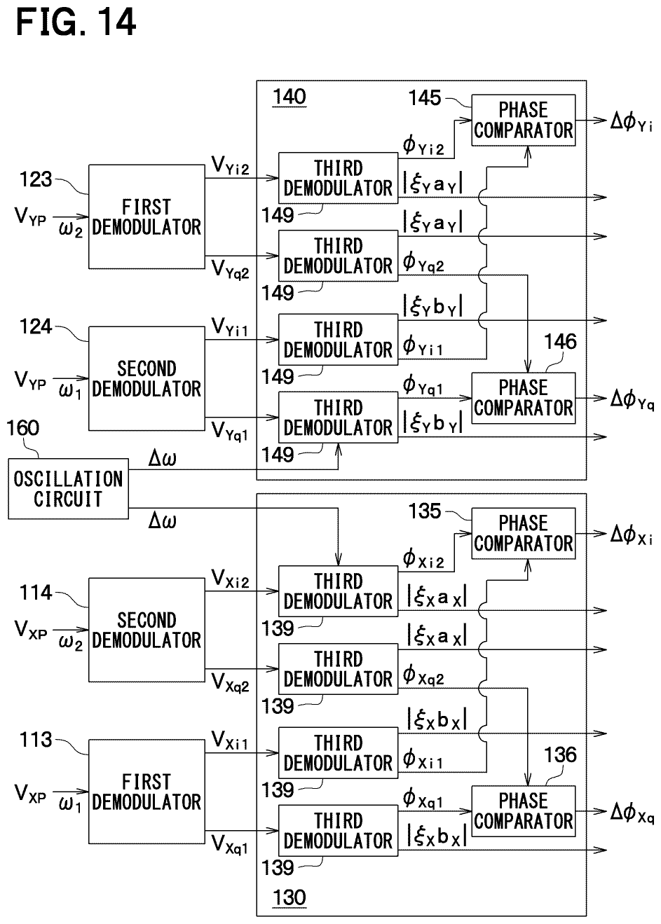

A gyro sensor 1 according to a second embodiment will be described with reference to FIGS. 13 and 14. In FIG. 14, the feedback from the first demodulator 113 to the PLL circuit 110 and the AGC circuit 111 and the feedback from the first demodulator 123 to the PLL circuit 120 and the AGC circuit 121 are omitted for ease of viewing.

The gyro sensor 1 according to the present embodiment is different from the first embodiment in that a configuration of the control unit 10 is changed, for example, as illustrated in FIG. 13. In the present embodiment, this difference will be mainly described.

In the present embodiment, for example, as illustrated in FIG. 13, the control unit 10 further includes an oscillation circuit 160, and a signal from the oscillation circuit 160 is input to the demodulation output calculators 130 and 140. The oscillation circuit 160 calculates a difference Δω between the two resonance frequencies ω₁ and we on the basis of the drive signals output from the two PLL circuits 110 and 120, for example. Then, the oscillation circuit 160 outputs a frequency signal having a frequency of Δω to the demodulation output calculators 130 and 140, respectively.

In the present embodiment, for example, as illustrated in FIG. 14, the first demodulation output calculator 130 includes a plurality of third demodulators 139 that performs demodulation processing on the demodulation outputs from the demodulators 113 and 114, respectively, and phase comparison units 135 and 136. Note that, FIG. 14 illustrates only one signal input from the oscillation circuit 160 of the plurality of third demodulators 139 and 149, and signal inputs to the other third demodulators are omitted for ease of viewing.

The plurality of third demodulators 139 calculates |ξ_{X}a_{X}| and |ξ_{X}b_{X}| of amplitude information and phase information φ_{Xi1}, φ_{Xq1}, φ_{Xi2}, and φ_{Xq2} on the basis of the demodulation outputs V_{Xi1}, V_{Xq1}, V_{Xi2}, and V_{Xq2} and the frequency signal of Δω input from the oscillation circuit 160. The phase comparison unit 135 calculates a phase difference Δφ_{Xi} on the basis of the phase information φ_{Xi1} and φ_{Xi2} from the third demodulator 139, for example. The phase comparison unit 136 calculates a phase difference Δφ_{Xq} on the basis of the phase information φ_{Xq1} and φ_{Xq2} from the third demodulator 139, for example.

In the present embodiment, for example, the second demodulation output calculator 140 includes a plurality of third demodulators 149 that performs demodulation processing on the demodulation outputs from the demodulators 123 and 124, respectively, and phase comparison units 145 and 146.

The plurality of third demodulators 149 calculates |ξ_{Y}a_{Y}| and |ξ_{Y}b_{Y}| of the amplitude information and phase information φ_{Yi1}, φ_{Yq1}, φ_{Yi2}, and φ_{Yq2} on the basis of the demodulation outputs V_{Yi1}, V_{Yq1}, V_{Yi2}, and V_{Yq2} and the frequency signal of Δω input from the oscillation circuit 160. The phase comparison unit 145 calculates a phase difference Δφ_{Yi} on the basis of the phase information φ_{Yi1} and φ_{Yi2} from the third demodulator 149, for example. The phase comparison unit 146 calculates a phase difference Δφ_{Yq} on the basis of the phase information φ_{Yq1} and φ_{Yq2} from the third demodulator 149, for example.

The amplitude information and the phase information obtained by the calculation in the demodulation output calculators 130 and 140 are output to the control circuit 150 and used for feedback control of θ_{ωβ}=0 as in the first embodiment.

In the present embodiment, the gyro sensor 1 can obtain a similar effect to the effect of the first embodiment.

### Other Embodiments

Although having been described in accordance with examples, the present disclosure should not be limited to the examples and structures. The present disclosure also includes various modifications and changes within the range of equivalency. In addition, various combinations and forms, as well as other combinations and forms that include only one element, more, or less, are within the scope and range of spirit of the present disclosure.

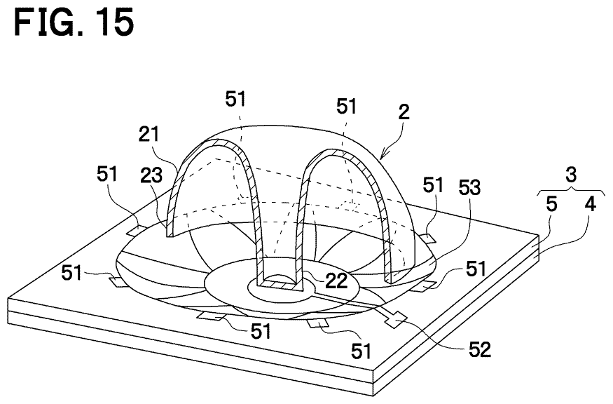

In the embodiment, an exemplary structure has been described in which the first electrode portion 51 is formed by dividing a base material such as silicon by etching, and including a plurality of facing portions facing the rim 23 apart from each other and an electrode film (not illustrated) covering a top surface of the facing portion and the like, but the present disclosure is not limited to this exemplary structure. In the sensor element, for example, as illustrated in FIG. 15, one substantially hemispherical recess 53 may be formed in the upper substrate 5, and the plurality of first electrode portions 51 may include only an electrode film covering a surface of the recess 53. In this case, for example, similarly to the first electrode portions 51, the second electrode portion 52 can include only an electrode film covering the surface of the upper substrate 5. In addition, the second electrode portion 52 only needs to be electrically connected to a portion of the recess 53 connected to the oscillator 2 while being electrically independent of the plurality of first electrode portions 51, and a voltage only needs to be able to be applied to the oscillator 2. For example, in the sensor element, a through electrode (not illustrated) extending along the thickness direction of the mounting substrate 3 is formed in a portion of the recess 53 to which the oscillator 2 is connected, and the sensor element may include only an electrode film connected to the through electrode. In the sensor element, when a mounting surface of the mounting portion 22 of the oscillator 2 protrudes more than the rim 23, the mounting substrate 3 does not need to have the recess 53, and the first electrode portion 51 and the second electrode portion 52 may include only the electrode film covering the surface of the upper substrate 5. As described above, the configurations of the first electrode portion 51 and the second electrode portion 52 in the sensor element may be appropriately changed, or may be another known configuration. In FIG. 15, in order to make the configurations of the electrode portions 51 and 52 easy to understand, a cross section is illustrated with a part of the oscillator 2 omitted.

In the sensor element, the configuration in which the oscillator 2 has a substantially hemispherical shape or a substantially disk shape and the plurality of first electrode portions 51 is arranged so as to surround the oscillator 2 has been described as a representative example, but the sensor element is not limited to such a form. For example, in the gyro sensor 1, as long as the sensor element can be regarded as the oscillating body of the two-degree-of-freedom system illustrated in FIG. 5, the control unit 10 can control a constant mode match. Therefore, the form, arrangement, and the like of the oscillator 2 and the electrode portions 51 and 52 may be other known forms, arrangement, and the like.

A control unit 10 and a method of the control unit described in the present disclosure may be achieved by a dedicated computer provided by configuring a processor and a memory programmed to execute one or a plurality of functions embodied by a computer program. Alternatively, the control unit 10 and the method of the control unit described in the present disclosure may be achieved by a dedicated computer provided by configuring a processor with one or more dedicated hardware logic circuits. Alternatively, the control unit 10 and the method of the control unit described in the present disclosure may be achieved by one or more dedicated computers configured by a combination of a processor and a memory programmed to execute one or a plurality of functions and a processor configured by one or more hardware logic circuits. The computer program may be stored in a computer-readable non-transitory tangible recording medium as an instruction executed by a computer.

In each of the embodiments, it goes without saying that the elements constituting the embodiments are not necessarily essential except for a case where it is explicitly stated that the elements are particularly essential and a case where the elements are considered to be obviously essential in principle. In each of the embodiments, when a numerical value such as the number, numerical value, amount, or range of the components of the embodiment is mentioned, the numerical value is not limited to a specific number unless otherwise specified as essential or obviously limited to the specific number in principle. In each of the embodiments, when referring to the shape, positional relationship, and the like of the constituent elements and the like, the shape, positional relationship, and the like are not limited unless otherwise specified or limited to a specific shape, positional relationship, and the like in principle.

What is claimed is:

1. A gyro sensor comprising:
an oscillator having a first oscillation mode and a second oscillation mode having different resonance frequencies;
a mounting substrate having a plurality of electrodes facing the oscillator, wherein a radial direction is defined to have an axis passing through a center of a region surrounded by the plurality of electrodes along a thickness direction of the mounting substrate, two directions along the radial direction and along a drive electrode of the plurality of electrodes used for driving the first oscillation mode and the second oscillation mode are defined as an electrode axis, two directions along the radial direction and along an oscillation direction of the first oscillation mode and the second oscillation mode are defined as an oscillation axis;
a first PLL circuit that controls a frequency of a drive signal for oscillating the oscillator in the first oscillation mode;
a second PLL circuit that controls a frequency of a drive signal for oscillating the oscillator in the second oscillation mode;
a first demodulator that calculates a first demodulation output on a basis of a first detection signal from the electrode that detects oscillation in the first oscillation mode among the plurality of electrodes and a first drive signal having a frequency for resonantly driving the first oscillation mode, output from the first PLL circuit, and a second demodulation output on a basis of a second detection signal from the electrode that detects oscillation in the second oscillation mode among the plurality of electrodes and a second drive signal having a frequency for resonantly driving the second oscillation mode, output from the second PLL circuit;
a second demodulator that calculates a third demodulation output on a basis of the first detection signal and the second drive signal, and a fourth demodulation output on a basis of the second detection signal and the first drive signal;
a first demodulation output calculator that calculates an amplitude and a phase of the first oscillation mode on a basis of the first demodulation output and the third demodulation output;
a second demodulation output calculator that calculates an amplitude and a phase of the second oscillation mode on a basis of the second demodulation output and the fourth demodulation output; and
a control circuit that outputs a control signal that causes the oscillation axis and the electrode axis to coincide with each other on a basis of an input signal regarding the amplitude and the phase from the first demodulation output calculator or the second demodulation output calculator.

2. The gyro sensor according to claim 1, wherein
the first demodulation output calculator includes a high-pass filter that cuts a part of the first demodulation output and the third demodulation output, a calculator that calculates an amplitude of the first oscillation mode by calculating a sum of squares by squaring and adding the first demodulation output and the third demodulation output after passing through the high-pass filter, and a phase comparison unit that calculates a phase of the first oscillation mode on a basis of the first demodulation output and the third demodulation output after passing through the high-pass filter, and
the second demodulation output calculator includes a high-pass filter that cuts a part of the second demodulation output and the fourth demodulation output, a calculator that calculates an amplitude of the second oscillation mode by calculating a sum of squares by squaring and adding the second demodulation output and the fourth demodulation output after passing through the high-pass filter, and a phase comparison unit that calculates a phase of the second oscillation mode on a basis of the second demodulation output and the fourth demodulation output after passing through the high-pass filter.

3. The gyro sensor according to claim 1, further comprising an oscillation circuit that outputs a frequency signal of a difference between a resonance frequency of the first oscillation mode and a resonance frequency of the second oscillation mode on a basis of the first drive signal and the second drive signal, wherein
the first demodulation output calculator includes a third demodulator that performs demodulation processing by using the frequency signal from the oscillation circuit and calculates an amplitude and a phase of the first oscillation mode, and
the second demodulation output calculator includes a third demodulator that performs demodulation processing by using the frequency signal from the oscillation circuit and calculates an amplitude and a phase of the second oscillation mode.

4. The gyro sensor according to claim 2, further comprising a PI circuit that outputs a control signal that makes a difference between a resonance frequency of the first oscillation mode and a resonance frequency of the second oscillation mode on a basis of the input signal from the first demodulation output calculator or the second demodulation output calculator.
